(19) United States
(12) Patent Application Publication
(10) Pub. No.: US 2013/0163917 A1
(43) Pub. Date: Jun. 27, 2013

(54) OPTICAL SUBASSEMBLY WITH AN EXTENDED RF PIN

(71) Applicant: FINISAR CORPORATION, Sunnyvale, CA (US)

(72) Inventors: Maziar Amirkiai, Sunnyvale, CA (US); Yunpeng Song, Fremont, CA (US); Hongyu Deng, Saratoga, CA (US)

(73) Assignee: FINISAR CORPORATION, Sunnyvale, CA (US)

(21) Appl. No.: 13/720,512

(22) Filed: Dec. 19, 2012

Related U.S. Application Data
(60) Provisional application No. 61/579,878, filed on Dec. 23, 2011.

(51) Int. Cl. G02B 6/42

(52) U.S. Cl. CPC G02B 6/4201
USPC 385/14; 385/92

(57) ABSTRACT

An optical subassembly (OSA) with an extended radio frequency (RF) pin. In one example embodiment, an OSA includes a header, a metallic ring, an RF insulator eyelet, and an RF pin. The header defines an insulator opening and includes an internal header surface. The metallic ring extends above the internal header surface and includes a metallic ring inner diameter substantially equivalent to a diameter of the insulator opening. The RF insulator eyelet is positioned partially in the insulator opening and partially in the metallic ring and defines an RF pin opening. The RF pin is positioned in the RF pin opening and extends through the insulator opening and the metallic ring.

### CROSS REFERENCE TO A RELATED APPLICATION

This application claims priority to and the benefit of U.S. Provisional Patent Application Serial No. 61/579,878, titled “OPTICAL SUBASSEMBLY WITH AN EXTENDED RF PIN,” filed on Dec. 23, 2011.

### BACKGROUND

1. Field of the Invention

Embodiments relate generally to optical subassemblies (OSAs). More particularly, example embodiments relate to an OSA with an extended radio frequency (RF) pin.

2. Related Technology

Communication modules, such as electronic or optoelectronic transceivers or transponder modules, are increasingly used in electronic and optoelectronic communication. Communication modules communicate with a host device printed circuit board by transmitting and/or receiving electrical data signals to and/or from the host device printed circuit board. The electrical data signals may also be transmitted by the communication module outside a host device as optical and/or electrical data signals. Many communication modules include OSAs such as transmitter optical subassemblies (individually a “TOSA”) and/or receiver optical subassemblies (individually a “ROSA”) to convert between the electrical and optical domains.

Generally, a ROSA transforms an optical signal received from an optical fiber or other source to an electrical signal provided to the host device, while a TOSA transforms an electrical signal received from the host device to an optical signal emitted onto an optical fiber or other transmission medium. A photodiode or similar optical receiver contained by the ROSA transforms the optical signal to the electrical signal. A laser diode or similar optical transmitter contained within the TOSA is driven to emit an optical signal representing the electrical signal received from the host device.

One difficulty related to OSA design and operation is controlling impedance variations in the electrical connections between an OSA and a host device printed circuit board. Generally, impedance is the resistance or opposition to alternating current and is measured in ohms. Failure to control impedance variations in these electrical connections may result in degradation in performance of the OSA due to increased standing waves, decreased power efficiency, increased heat generation, and increased noise.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Embodiments relate generally to optical subassemblies (OSAs). More particularly, example embodiments relate to an OSA with an extended radio frequency (RF) pin.

In one example embodiment, an OSA includes a header, a metallic ring, an RF insulator eyelet, and an RF pin. The header defines an insulator opening and includes an internal header surface. The metallic ring extends above the internal header surface and includes a metallic ring inner diameter substantially equivalent to a diameter of the insulator opening. The RF insulator eyelet is positioned partially in the insulator opening and partially in the metallic ring and defines an RF pin opening. The RF pin is positioned in the RF pin opening and extends through the insulator opening and the metallic ring.

In another example embodiment, an OSA includes a header, a metallic ring, an RF insulator eyelet, an RF pin, and a transducer. The header defines an insulator opening and includes an internal header surface. The metallic ring extends above the internal header surface and includes a metallic ring inner diameter substantially equivalent to a diameter of the insulator opening. The metallic ring has a terminal end. The RF insulator eyelet is positioned partially in the insulator opening and partially in the metallic ring and defines an RF pin opening and a terminal end. The RF pin is positioned in the RF pin opening and extends through the insulator opening and the metallic ring. The RF pin includes a terminal end that extends roughly to the terminal end of the metallic ring and to the terminal end of the RF insulator eyelet. The transducer is positioned at roughly the same height above the internal header surface as the terminal ends of the metallic ring, the RF insulator eyelet, and the RF pin.

In yet another example embodiment, an optoelectronic transceiver module includes a housing, a printed circuit board (PCB) at least partially positioned within the housing, a port defined in the housing and configured to receive an optical fiber, and an OSA at least partially positioned within the housing. The OSA includes a header, a metallic ring, an RF insulator eyelet, an RF pin, a TEC, and a transducer. The header defines an insulator opening and includes an internal header surface. The metallic ring extends above the internal header surface and includes a metallic ring inner diameter substantially equivalent to a diameter of the insulator opening. The metallic ring has a terminal end. The RF insulator eyelet is positioned partially in the insulator opening and partially in the metallic ring and defines an RF pin opening and a terminal end. The RF pin is in electrical communication with the PCB. The RF pin is positioned in the RF pin opening and extends through the insulator opening and the metallic ring. The RF pin includes a terminal end that extends roughly to the terminal end of the metallic ring and to the terminal end of the RF insulator eyelet. The TEC is positioned above the internal header surface. The transducer is optically aligned with the port and is positioned above the TEC at roughly the same height above the internal header surface as the terminal ends of the metallic ring, the RF insulator eyelet, and the RF pin.

It is to be understood that both the foregoing summary and the following detailed description are exemplary and explanatory and are not restrictive of the invention, as claimed.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view of an example transceiver;

FIG. 1B is a partially exploded perspective view of the example transceiver of FIG. 1A;

FIGS. 2A and 2B are perspective views of an example optical subassembly that may be employed in the transceiver of FIGS. 1A and 1B;

FIG. 2C is a cutaway side view of the example optical subassembly depicted in FIGS. 2A and 2B;

FIG. 3A is a perspective view of an example optical-electric interface that may be implemented in the optical subassembly of FIGS. 2A-2C;

FIG. 3B is a cutaway side view of the example optical-electric interface that may be implemented in the optical subassembly of FIGS. 2A-2C; and

FIG. 4 is an RF assembly that may be implemented in the optical-electric interface of FIGS. 3A-3B.

### DETAILED DESCRIPTION

Embodiments relate generally to optical subassemblies (OSAs). More particularly, example embodiments relate to an OSA with an extended radio frequency (RF) pin.

As used herein, the term “optoelectronic device” includes a device having both optical and electrical components. Examples of optoelectronic devices include, but are not limited to, transponders, transceivers, transmitters, and/or receivers. While the invention will be discussed in the context of a transceiver or an optoelectronic device, those of skill in the art will recognize that the principles of the present invention may be implemented in other electronic devices having the functionality described below.

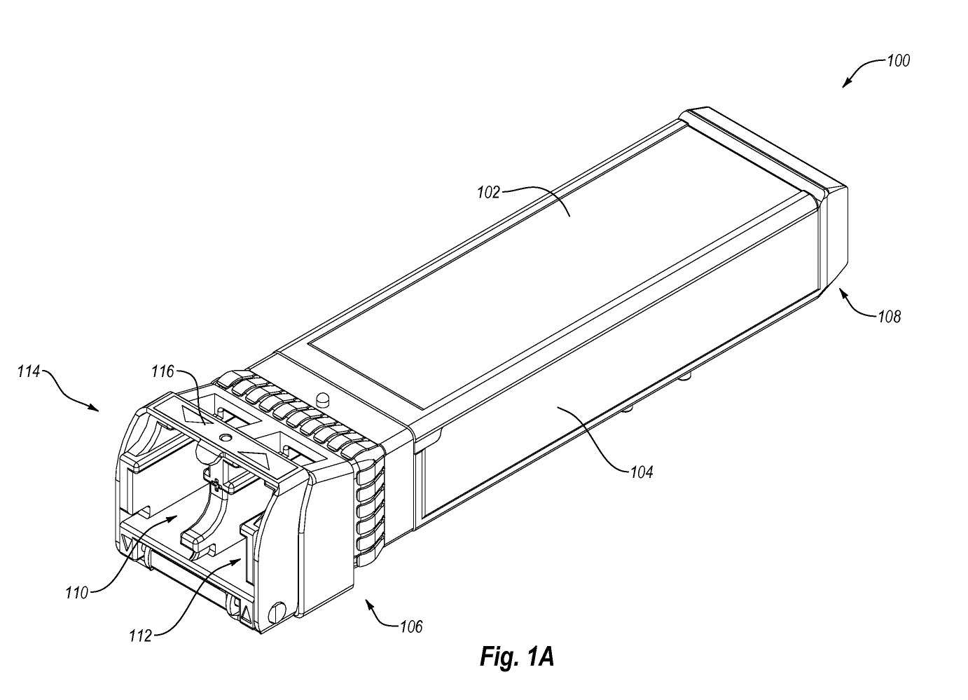

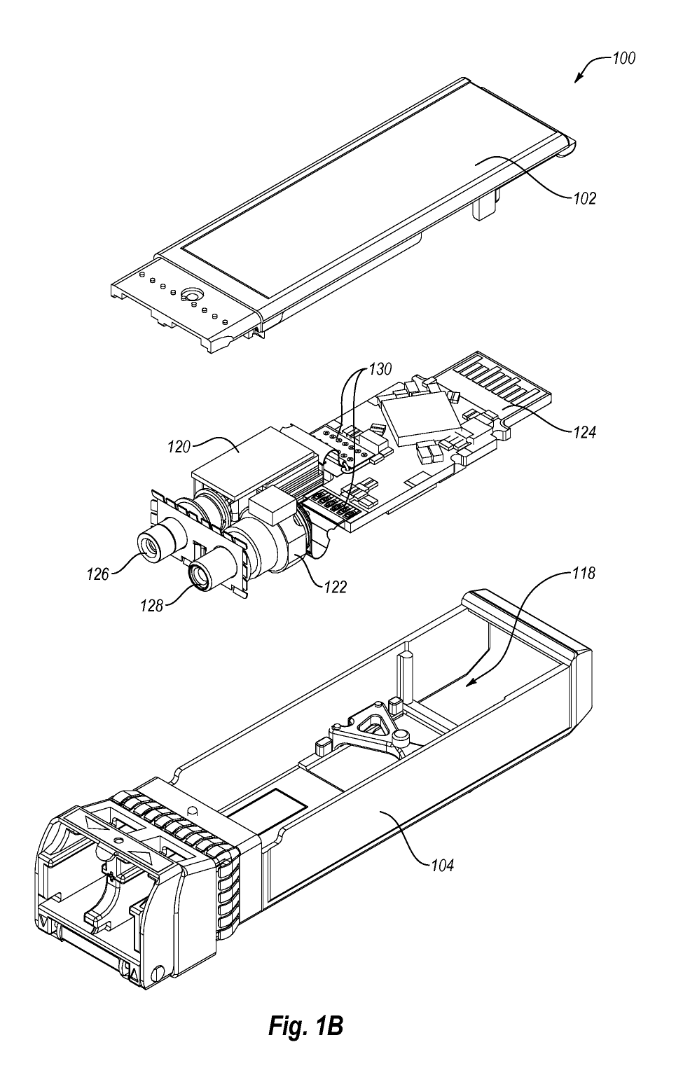

FIG. 1A illustrates a perspective view of an example transceiver module generally designated as transceiver 100 in which an extended RF pin may be implemented. While described in some detail herein, the transceiver 100 is discussed by way of illustration only, and not by way of restricting the scope of the invention. For example, although the transceiver 100 is substantially compliant with the SFP+MSA, the principles of the invention may be implemented in optoelectronic devices that are substantially compliant with other form factors including, but not limited to, XFP, SFP, SFF, XENPAK, and XPAK. Alternatively or additionally, the transceiver 100 may be suitable for optical signal transmission and reception at a variety of per-second data rates, including but not limited to, 1 Gbit, 2 Gbit, 4 Gbit, 8 Gbit, 10 Gbit, 20 Gbit, or higher bandwidth fiber-optic links. Furthermore, optoelectronic devices of other types and configurations, or having components that differ in some respects from those shown and described herein, may also benefit from the principles disclosed herein.

As shown in FIG. 1A, the transceiver 100 includes a housing composed of a top shell 102 and bottom shell 104. The bottom shell 104 defines a front end 106 and a rear end 108 of the transceiver 100. Included on the front end 106 of the transceiver 100 bottom shell 104 are an output port 110 and an input port 112 configured to receive connectors of an optical fiber (not shown). The optical ports 110 and 112 define a portion of an interface portion 114 that is generally included on the front end 106 of the transceiver 100. The interface portion 114 may include structures to operably connect the transceiver 100 to optical fibers or optical fiber connectors such as LC connectors.

In addition, disposed on the transceiver 100 front end 106 is a bail latch assembly 116 that enables the transceiver 100 to be removably secured in a host device (not shown). The housing of the transceiver 100, including top shell 102 and bottom shell 104, may be formed of metal. Additionally, a host device may include a cage in which the transceiver 100 may be inserted.

FIG. 1B illustrates an exploded perspective view of the example transceiver 100 of FIG. 1A. In FIG. 1B, the bottom shell 104 defines a cavity 118 in which a TOSA 120, a ROSA 122, a PCB 124, and PCB electrical connectors 130 are included as internal components of the transceiver 100.

Each of the TOSA 120 and the ROSA 122 includes a port 126 and 128, respectively, that extends into a respective one of the optical ports 110 and 112 so as to be positioned to mate with an optical fiber (not shown) or a connector portion (not shown) of the optical fiber when received within optical ports 110 and 112. The TOSA 120 and the ROSA 122 may be electrically coupled to the PCB 124 via the PCB electrical connectors 130. The PCB electrical connectors 130 may include a lead frame connector or equivalent electrical contact(s) that allow the transmission of electrical signals from the PCB 124 to the TOSA 120 and/or the ROSA 122.

During operation, the transceiver 100 may receive a data-carrying electrical signal from a host device, which may be any computing system capable of communicating with the transceiver 100, for transmission as a data-carrying optical signal on an optical fiber (not shown). The electrical signal may be provided to an optical transmitter, such as a laser disposed within the TOSA 120 (not shown), which converts the electrical signal into a data-carrying optical signal for transmission on an optical fiber and transmission via an optical communication network, for instance. The optical transmitter may include an edge-emitting laser diode, a Fabry-Perot (FP) laser, a vertical cavity surface-emitting laser (VCSEL), a distributed feedback (DFB) laser, or other suitable light source. Accordingly, the TOSA 120 may serve or include components that serve as an electro-optical transducer.

In addition, the transceiver 100 may receive a data-carrying optical signal from an optical fiber via the ROSA 122. The ROSA 122 may include an optical receiver, such as a photodiode or other suitable receiver, which transforms the received optical signal into a data-carrying electrical signal. Accordingly, the ROSA 122 may include components that serve as an opto-electrical transducer. The resulting electrical signal may then be provided to the host device in which the transceiver 100 is located.

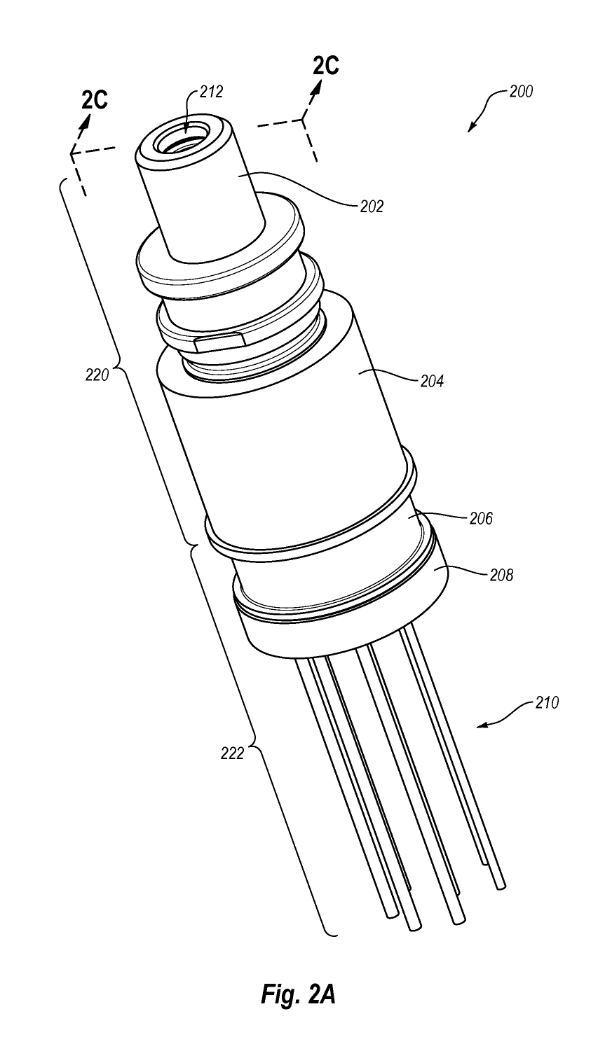

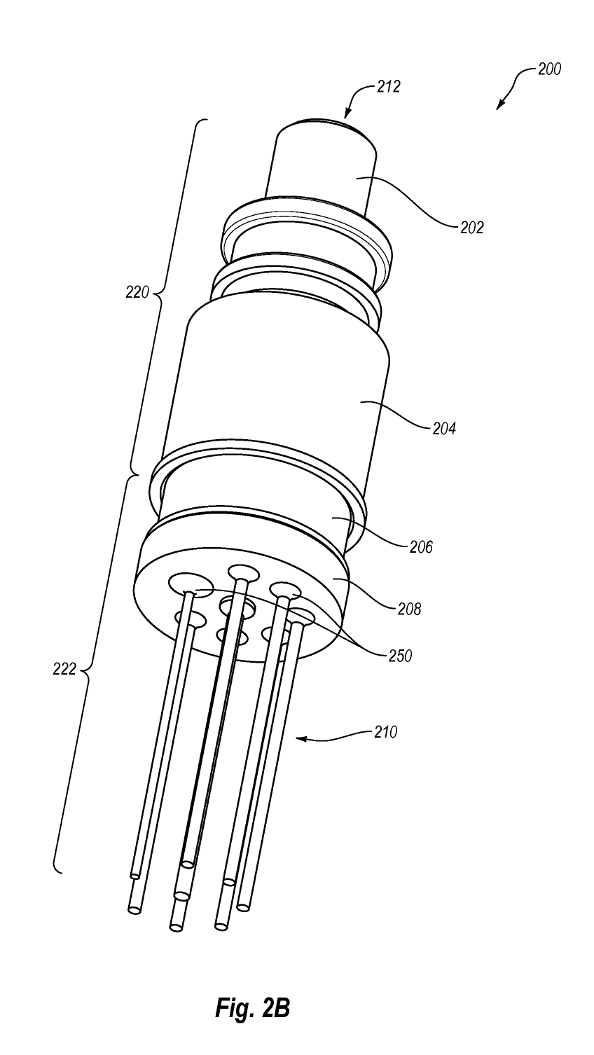

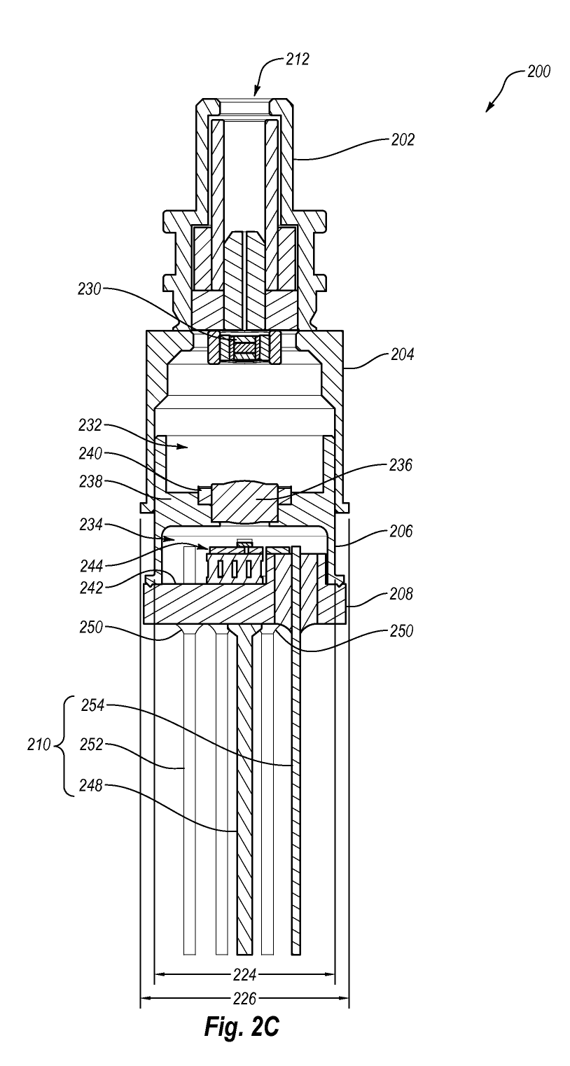

FIGS. 2A-2C illustrate an example OSA 200 with an extended RF pin. Specifically, FIG. 2A illustrates a front, perspective view of the OSA 200. FIG. 2B illustrates a rear perspective view of the OSA 200. FIG. 2C illustrates a cutaway side view of the OSA 200. Generally, the OSA 200 illustrated in FIGS. 2A-2C is representative of an OSA such as a ROSA or a TOSA that may be included in an optical transceiver such as the transceiver 100 depicted in FIGS. 1A and 1B. The OSA 200 is a TOSA, but this is not meant to limit the scope of the invention and instead is included to provide a specific example operating environment.

Generally, the OSA 200 may include a barrel 202 that may be attached to a cap 204. The cap 204 may receive a housing 206 that may be attached to a header 208. Additionally, pins 210 may extend from the header 208. For explanatory convenience, the OSA 200 may further include an optical end 220 and an electrical end 222. The optical end 220 generally relates to the portion of the optical subassembly including the barrel 202 that interfaces with an optical network (not shown). In contrast, the electrical end 222 generally relates to the portion of the OSA 200 that includes the pins 210 that electrically interfaces with a PCB, such as PCB 124 of FIG. 1B, and consequentially with a host device electrically coupled to the PCB. Again, designation of the optical end 220 and the electrical end 222 is for explanatory convenience; accordingly, there is not an exact dividing line between the optical end 220 and the electrical end 222.

The optical end 220 of the OSA 200 may include the barrel 202 that may define a port 212. The port 212 may be configured to receive an optical fiber (not shown), which may provide an interface between the OSA 200 and an optical network. The port 212 of the barrel 202 may support and/or secure the optical fiber, enabling communication of optical signals through the optical fiber. For example, optical signals may be generated in the OSA 200 and transmitted through the optical fiber in embodiments where the OSA 200 is a TOSA, similar to the TOSA 120 of FIG. 1B. Alternatively, optical signals may be received from the optical fiber in embodiments where the OSA 200 is a ROSA, similar to the ROSA 122 of FIG. 1B.

As illustrated in FIG. 2C, the barrel 202 and the port 212 may further include various components such as a split sleeve, a split sleeve receptacle, a fiber stub, and inner rings. These components generally relate to supporting and/or securing the optical fiber for the function(s) described above.

Referring to FIGS. 2A and 2B, the OSA 200 may include the cap 204. Viewing the cap 204 from the exterior of the OSA 200, the cap 204 may be shaped as a cylinder extending from the barrel 202 to the housing 206. In some embodiments, the cap 204 may be attached to the barrel 202 and/or the housing 206. For example, the barrel 202 and/or the housing 206 may be received into the cap 204. For example, as depicted in FIG. 2C, the housing 206 may have a housing diameter 224 and the cap 204 may have a cap diameter 226. The housing diameter 224 may be smaller than the cap diameter 226 enabling the housing 206 to fit within the cap 204.

Additionally, an example internal configuration of the cap 204 is illustrated in FIG. 2C. An internal volume of the cap 204 may include a series of cylinders having diameters that diminish closer to the barrel 202. The cap 204 may retain and/or secure various components such as, but not limited to, isolators 230.

Referring again to FIGS. 2A and 2B, the OSA 200 may include the housing 206. Viewing the housing 206 from the exterior of the OSA 200, the housing 206 may be shaped as a cylinder extending from the cap 204 to the header 208. The housing 206 may be attached to the cap 204 and/or the header 208. For example, the housing 206 may be hermetically sealed to the header 208, which may prevent air or ambient conditions from entering the OSA 200.

An example internal configuration of the housing 206 is depicted in FIG. 2C. Although the OSA 200 is a TOSA, similar to the TOSA 120 of FIG. 1B, the housing 206 and the internal configuration of the housing 206 may vary significantly in embodiments where the OSA 200 is instead configured as a ROSA or other optical subassembly.

The housing 206 may include an upper housing cavity 232, a lower housing cavity 234, and a lens support disc 238 that separates the upper housing cavity 232 from the lower housing cavity 234. The lens support disc 238 may be configured to retain and/or secure a lens 236 and a lens solder 240.

The upper housing cavity 232 may be defined by the housing 206 and by the internal configuration of the cap 204. Specifically, in the depicted embodiment one boundary of the upper housing cavity 232 is the lens support disc 238. Additionally, a circumferential boundary of the upper housing cavity 232 may be defined by the housing 206 towards the lens support disc 238 and the circumferential boundary may be further defined by the internal configuration of the cap 204 nearer to the barrel 202. In alternative embodiments, the upper housing cavity 232 may be defined entirely by the cap 204 and/or the housing 206.

The upper housing cavity 232 is largely empty. During operation of the OSA 200, an optical signal may pass through the upper housing cavity 232. For example, optical signals generated in the OSA 200 may pass from an optical transmitter disposed in the lower housing cavity 234 (discussed below) through the lens 236 and into the upper housing cavity 232. The optical signal may then pass through the isolators 230 and into an optical fiber (not shown) received in the port 212.

The lower housing cavity 234 may be defined by the housing 206 and the header 208. In the depicted embodiment, for example, the lower housing cavity 234 is shaped as a cylinder having a first boundary defined by the lens support disc 238 and the lens 236, a circumferential boundary defined by the housing 206, and a second boundary defined by the header 208.

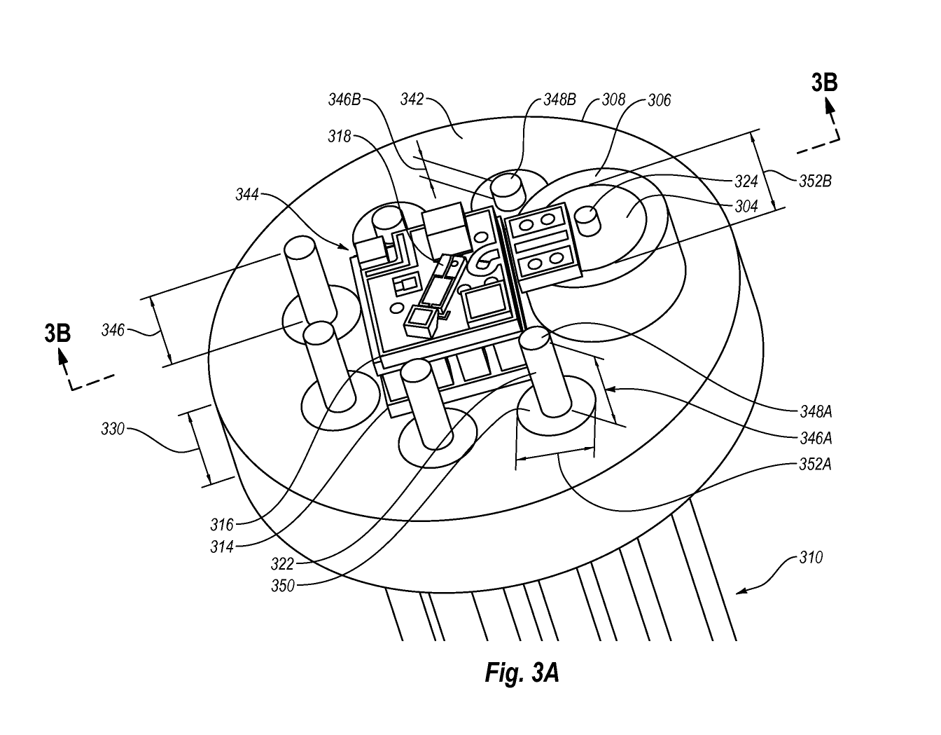

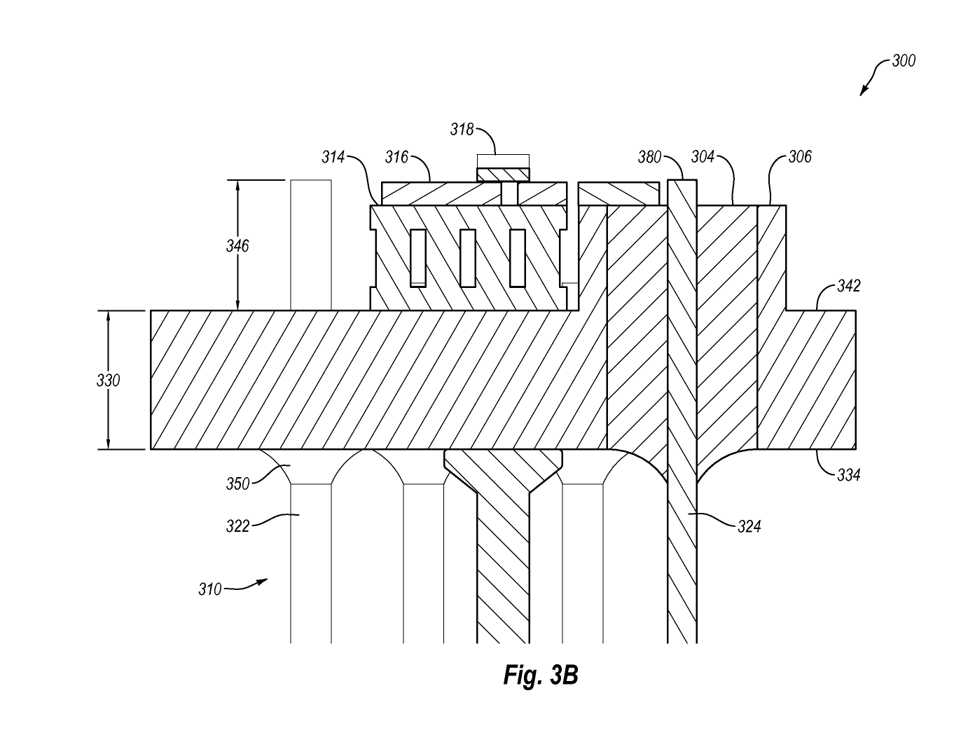

In the depicted embodiment, the lower housing cavity 234 defined by the housing 206 and the header 208 essentially defines a “TO package.” Optical/electrical components 244 may be disposed within the lower housing cavity 234. The optical/electrical components 244 that may be disposed within the lower housing cavity 234 may include, but are not limited to, an optical receiver, an optical transmitter, and/or components that modify, monitor, amplify, and/or attenuate optical and/or electrical signals to conform to operating capabilities of a system implementing the OSA 200. The optical/electrical components 244 disposed within the lower housing cavity 234 generally act as an optical-electrical interface that may convert signals between the electrical and optical domains. Various aspects of an optical-electrical interface are discussed with reference to FIGS. 3A-3B.

Referring again to FIGS. 2A-2C, in alternative embodiments, the housing 206 defines the lower housing cavity 234 such that a fully integrated TO package, such as a TO-46, may be received in the lower housing cavity 234. That is, the fully integrated TO package may be received in the lower housing cavity 234 without the housing 206 defining any portion of the TO package. Instead, a canister may contain the optical/electrical components such as optical/electrical components 244, and the housing 206 may support and/or retain the canister of the TO package. In other alternative embodiments, the lower housing cavity 234 may be defined solely by the housing 206 or the header 208 and/or may take another shape.

The OSA 200 also includes the header 208. Viewing the header 208 from the exterior of the OSA 200, the header 208 may be shaped as a cylinder and may be secured to the housing 206. The header 208 may also have pins 210 extending therefrom. In the depicted embodiment there are eight pins 210; however, the OSA 200 may include any number of pins 210.

The pins 210 may generally be configured as cylindrical rods that may extend outward parallel to an axis of the OSA 200 from the header 208. Additionally, the pins 210 may be substantially parallel to each other and the pins 210 may extend a substantially equal length from the header 208. However, in alternative embodiments, the pins 210 may diverge or converge as the pins 210 extend from the header 208. In alternative embodiments, the pins 210 may have shapes alternative to cylindrical rods, may extend at least partially radially, and/or may extend varying lengths from the header 208.

With combined reference to FIGS. 2A-2C, the header 208 may be sealed to the housing 206 and the optical/electrical components 244 that are disposed within the lower housing cavity 234 may be mounted to the header 208. Specifically, as illustrated in FIG. 2C, the optical/electrical components 244 may be mounted to an internal header surface 242. Also, the internal header surface 242 may act as a sealing surface for the connection between the header 208 and the housing 206.

One or more of the pins 210 may penetrate the header 208 to enter the lower housing cavity 234. The pins 210 may be electrically coupled to the optical/electrical components 244 mounted to the internal header surface 242.

The header 208 may be electrically grounded and/or act as an electrical ground for the OSA 200. To this end, the header 208 may be composed of rolled steel or another conductive material. In addition, one or more of the pins 210 may be a ground pin 248. In some embodiments, the ground pin 248 does not penetrate the header 208. Instead, in these embodiments the ground pin 248 may be welded, fastened, or equivalently secured to the header 208.

Each of the pins 210 may have electrical impedance. For example, the pins 210 may include one or more DC pins such as the DC pin 252 and/or one or more RF pins such as the RF pin 254. The DC pin 252 may have an impedance of 25 ohms and the RF pin 254 may have an impedance of 50 ohms.

In some embodiments, the OSA 200 may benefit from impedance matching between one or more of the pins 210 and one or more optical/electrical components 244. Example benefits may include elimination of standing waves, a gain in power efficiency, a reduction in heat generation, a reduction in noise, etc. Generally, impedance matching involves optimizing the ratio between a load impedance and the source impedance to ensure maximum energy transfer. For example, the RF pin 254 impedance may be matched to the impedance of a corresponding optical/electrical component 244 to transfer a maximum amount of energy from the RF pin 254 to the optical/electrical component 244 and improve noise performance.

The pins 210 may be insulated from and/or secured to the header 208 through insulator eyelets 250. The insulator eyelets 250 may be composed of glass, plastic, and/or some combination of these and/or other insulator materials. As best illustrated in FIGS. 2B and 2C, the insulator eyelets 250 may be fixed in the header 208 and surround a corresponding pin 210. Thus, the insulator eyelets 250 may secure the pins 210 to the header 208 while prohibiting the transfer of electrical signals between the header 208 and the pins 210. In embodiments of the OSA 200 implementing impedance matching, the dimensions of each insulator eyelet 250 may be optimized to establish an impedance of the corresponding pin 210.

Referring to FIGS. 3A, an example optical-electrical interface 300 is illustrated that may be implemented in the OSA 200 depicted in FIGS. 2A-2C. Generally, the optical-electrical interface 300 may include electrical/optical components of an optical subassembly such as OSA 200 that may convert signals between the electrical and optical domains. With combined reference to FIGS. 1B, 2A, and 3A, optical-electrical interface 300 may be located at the electrical end 222 of the OSA 200. The optical-electrical interface 300 may be located at the electrical end 222 because one function of the optical-electrical interface 300 may be to receive and/or to transmit electrical signals. For example, the optical-electrical interface 300 may receive electrical signals from the PCB 124 and transduce the electrical signals to optical signals. Additionally, the electrical-optical interface 300 may include a transduction device, such as an optical receiver and/or an optical transmitter. The transduction device may perform the conversion between the electrical and optical domains.

In the embodiment depicted in FIGS. 3A, the optical-electrical interface 300 is exposed by the removal of a housing such as housing 206 of FIGS. 2A-2C. The optical-electrical interface 300 generally includes a header 308, similar to the header 208 of FIGS. 2A-2C, with optical/electrical components 344 mounted on an internal header surface 342 and pins 310 that penetrate the header 308.

The optical/electrical components 344 may be mounted near the center of the internal header surface 342 such that the pins 310 surround the optical/electrical components 344 facilitating an electrical coupling between the pins 310 and the optical/electrical components 344. The pins 310 may be electrically coupled with the optical/electrical components 344 such that the electrical signals may be transmitted between the pins 310 and the optical/electrical components 344. For example, in embodiments with optical/electrical components 344 that include an optical transmitter, a driver (not shown) may transmit an electrical signal to the optical transmitter to drive a laser that generates an optical signal representative of the electrical signal. Additionally or alternatively, a portion of the optical signal may be attenuated and/or reflected to a monitor photodiode, transduced to an electrical signal, and transmitted to one of the pins 310.

Alternatively, in example embodiments with optical/electrical components 344 that include an optical receiver, an optical signal received by the optical receiver may be transduced to an electrical signal representative of the optical signal. The optical receiver may be electrically coupled to a corresponding pin 310 that communicates the electrical signal with a PCB such as the PCB 124 of FIG. 1B.

In the embodiment depicted in FIG. 3A, the optical/electrical components 344 include a thermoelectric cooler (TEC) 314, a ceramic sub-mount 316, and an electro-absorption modulated laser (EML) 318.

The EML 318 may be elevated above the internal header surface 342 in order to be mounted on the ceramic sub-mount 316, which is mounted on the TEC 314. The pins 310 that penetrate the header 308 may extend above the internal header surface 342 to a pin height 346 above the internal header surface 342. By extending the pins 310 to the pin heights 346 above the internal header surface 342, the burden placed on an electrical coupling mechanism, such as wire bonding, may be reduced. For example, if the pin height 346 brings a terminal end of the pin 310 level with one of the optical/electrical components 344, the electrical coupling mechanism may be shorter than if the pin height were lower.

The pin height 346 may be determined through pragmatic considerations usually relating to the height of the optical/electrical component 344 with which a particular pin 310 will be electrically coupled. For example, the embodiment depicted in FIG. 3A may include a long pin height 346A and a short pin height 346B. The long pin height 346A brings a first pin top 348A level with the optical/electrical components 344 mounted on the TEC 314 and the ceramic sub-mount 316. The short pin height 346B brings a second pin top 348B level with the optical/electrical components 344 mounted closer to the internal header surface 342. In the depicted embodiment, there are five pins 310 that extend above the internal header surface 342 to the long pin height 346A and two pins 310 that extend above the internal header surface 342 to the short pin height 346B. In alternative embodiments, there may be various pin heights and multiple pins may extend past the internal header surface 342 to the various pin heights.

Similar to the embodiment of FIG. 2C that includes ground pin 248, DC pin 252, and RF pin 254, the pins 310 of FIGS. 3A and 3B include one or more DC pins such as DC pin 322 and one or more RF pins such as RF pin 324. The depicted embodiment includes one RF pin 324 and six DC pins 322, although only one DC pin 322 is labeled. The DC pins 322 are surrounded by insulator eyelets 350 and penetrate the header 308. The insulator eyelets 350 that surround the DC pins 322 stop at the internal header surface 342 leaving an exposed portion of the DC pins 322 above the internal header surface 342.

In contrast, the RF pin 324 may be surrounded by an RF insulator eyelet 304 that extends above the internal header surface 342. Additionally or alternatively, the RF pin 324 may be surrounded by a metallic ring 306. Due to the RF insulator eyelet 304 and/or the metallic ring 306, the exposed portion of the RF pin 324 that extends above the internal header surface 342 is limited. The height of the metallic ring 306 may be roughly equal to the pin heights 346. The metallic ring 306 may be composed of rolled steel or another metal, for example. The metallic ring 306 may be forged, molded, or otherwise formed with the header. Alternatively, the metallic ring 306 may be formed separately and attached to the header by a suitable attachment method such as welding, an epoxy, a glue, and/or a fastener.

As used herein, the terms “substantially” and “roughly” are included to distinguish between two values that are essentially equal and two values that are closely related to one another but not essentially equal.

As disclosed in FIG. 3A, the insulator eyelets 350 have an eyelet diameter 352A and the RF insulator eyelet 304 has an eyelet diameter 352B (collectively “eyelet diameter 352”). The eyelet diameter 352 of each insulator eyelets 350, 304 may be sized to ensure proper insulation and/or impedance of a corresponding pin 310, i.e., DC pin 322 or RF pin 324. For example, in the optical-electrical interface 300, the DC pin 322 may have a 25-ohm impedance and the RF pin 324 may have a 50-ohm impedance. Correspondingly, the eyelet diameter 352A may be smaller than the eyelet diameter 352B.

In alternative embodiments, an optical-electrical interface 300 may include multiple RF pins 324 that may be configured to share one or more RF insulator eyelet(s) 304 and/or one or more metallic rings 306. For example, in an embodiment with two RF pins 324, the RF insulator eyelet 304 may be configured to receive both RF pins 324 and may further be inserted into a common metallic ring 306. In this and other example embodiments, the metallic ring 306 and/or RF insulator eyelet 304 may take various shapes.

Referring to FIG. 3B, a cutaway version of the optical-electrical interface 300 depicted in FIG. 3A is illustrated. The cutaway version of the optical-electrical interface 300 better illustrates the pin height 346 of the pins 310. The header 308 may include a header thickness 330. The header thickness 330 may be the dimension between the internal header surface 342 and the external header surface 334. The insulator eyelets 350 of the DC pins 322 may have an insulator height equal to the header thickness 330. That is, the insulator eyelets 350 begin roughly at the external header surface 334 and end at substantially the internal header surface 342 while surrounding the DC pins 322. The DC pins 322 thus have exposed portions equal to the pin heights 346. In some embodiments, the pin heights 346 are equal to a height of the TEC 314 added to the height of the ceramic sub-mount 316.

However, in the depicted and some other embodiments, the RF insulator eyelet 304 and/or the metallic ring 306 extend up from the internal header surface 342. The RF pin 324 may thus be surrounded by the RF insulator eyelet 304 and/or the metallic ring 306 from roughly the exterior header surface 334 beyond the internal header surface 342 and up to a terminal extent of the RF insulator eyelet 304 and/or metallic ring 306.

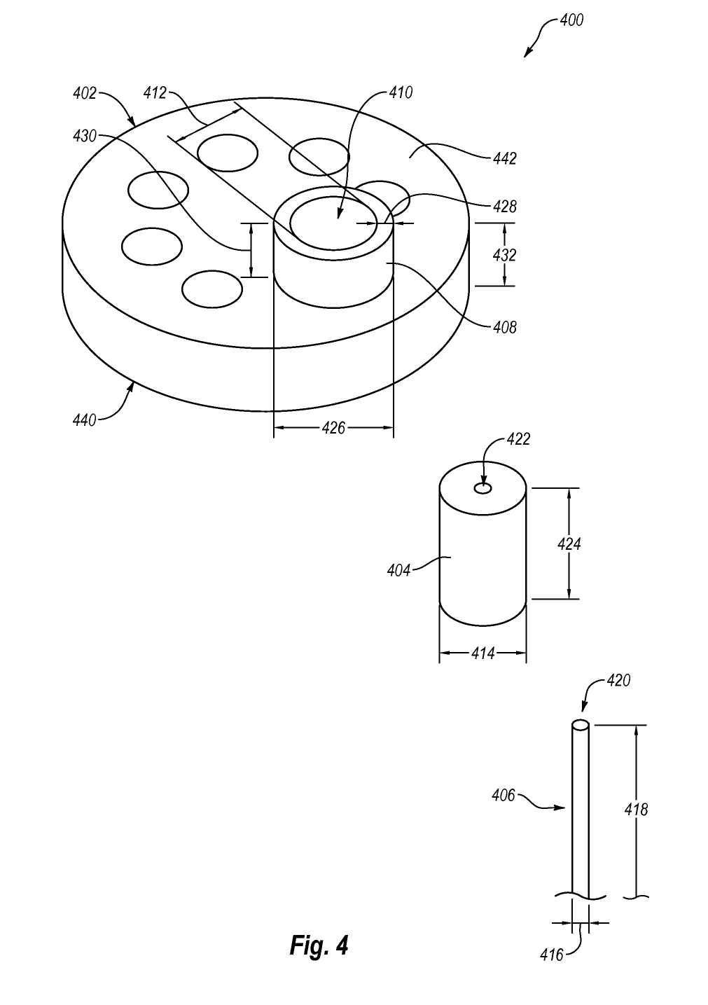

FIG. 4 illustrates the RF assembly 400 that may be implemented in the optical-electrical interface depicted in FIGS. 3A-3B. Generally, the RF assembly 400 enables the matching of an impedance of an RF pin 406 with an impedance of a corresponding optical/electrical component (not shown). The impedance matching may be accomplished by fixing a metallic ring 408 on a header 402 that defines an insulator opening 410. The RF pin 406, which may be surrounded by an RF insulator eyelet 404, may be inserted into the insulator opening 410 and further into the metallic ring 408. By deliberately sizing the RF pin 406, the RF insulator eyelet 404, and the metallic ring 408, the impedance of the RF pin 406 may be matched with the impedance of the corresponding optical/electrical component.

The RF pin 406 may generally take the shape of a cylindrical rod and may be composed of an electrically-conductive material such as a metal. The RF pin 406 may include an RF pin diameter 416, a terminal end 420, and an RF pin penetration length 418. The RF pin diameter 416 may be the outer diameter of the cylindrical rod. The RF pin penetration length 418 may be the length from the terminal end 420 to point on the RF pin 406 corresponding to an external header surface 440 when the RF pin 406 is inserted into the header 402. In the example illustrated in FIG. 3B, the RF pin penetration length extends from the external header surface 334 to the terminal end 380.

The RF pin 406 may be configured to carry electrical signals that oscillate at radio frequencies (RF signals). The RF pin 406 may be electrically coupled to an optical/electrical component. For example, the RF pin 406 may be electrically coupled to an optical/electrical component by forming a wire bond between the RF pin terminal end 420 and an electrical contact on the optical/electrical component.

The RF insulator eyelet 404 may have an RF pin opening 422, an RF insulator height 424, and an RF insulator eyelet outer diameter 414. The RF pin opening 422 may have a diameter substantially equal to the RF pin diameter 416. The RF pin opening 422 may receive the RF pin 406 such that the RF pin 406 is sealed to the RF insulator eyelet 404. The seal between the RF pin 406 and the RF insulator eyelet 404 may prevent or reduce the introduction of ambient conditions between the RF pin 406 and the RF insulator eyelet 404.

The RF insulator height 424 may be roughly equivalent to the RF pin penetration length 418. That is, the RF insulator eyelet 404 may extend from the point on the RF pin 406 corresponding to the external header surface 440 when the RF pin 406 is inserted into the header 402 to roughly the RF pin terminal end 420. For example, the RF insulator height 424 may be slightly shorter than the RF pin penetration length 418 to reduce physical interference with an electrical coupling, such as a bond wire, between the RF pin 406 and the optical/electrical component.

The RF insulator eyelet outer diameter 414 may correspond to a diameter of an insulator opening 410 defined in the header 402. Additionally, the RF insulator eyelet outer diameter 414 may correspond to the metallic ring inner diameter 412 of the metallic ring 408. The correspondency between the insulator opening 410, the RF insulator eyelet outer diameter 414, and the metallic ring inner diameter 412 enables the RF insulator eyelet 404 to fit within the insulator opening 410 and the metallic ring 408.

The header 402 further includes an internal header surface 442. The metallic ring 408 may extend from the internal header surface 442. As stated above, the metallic ring 408 may include the metallic ring inner diameter 412 that is substantially equivalent to the diameter of the insulator opening 410. When the metallic ring 408 is oriented to be concentric with and aligned with the insulator opening 410, the metallic ring 408 may function as a continuous extension of the insulator opening 410. Thus, the RF insulator eyelet 404 may be received in the insulator opening 410 and the metallic ring 408.

The metallic ring 408 may be pipe-shaped or tube-shaped and may include a metallic ring outer diameter 426. The metallic ring outer diameter 426 may be equal to the metallic ring inner diameter 412 plus twice a ring thickness 428. The ring thickness 428 may be varied by increasing or decreasing the metallic ring outer diameter 426.

The metallic ring 408 may include a metallic ring height 430. The metallic ring height 430 is the distance the metallic ring 408 extends above the internal header surface 442. The metallic ring height 430 may be substantially equivalent to the RF insulator height 424 minus a header thickness 432. The header thickness 432 is equal to the distance between the internal header surface 442 and the external header surface 440. Additionally or alternatively, the metallic ring height 430 may be roughly equivalent to the RF pin penetration length 418 minus the header thickness 432. Generally, the header thickness 432 in addition to the metallic ring height 430 are such that the entire RF insulator eyelet 404 is roughly surrounded. Additionally, the header thickness 432 in addition to the metallic ring height 430 are such that the entire RF pin penetration length 418 of the RF pin 406 is roughly surrounded when the RF pin 406 is inserted into the RF insulator eyelet 404 and further inserted into the insulator opening 410 and metallic ring 408.

Together, the RF insulator eyelet 404, the metallic ring 408, the RF pin diameter 416, and the header 402 may combine to establish the impedance of the RF pin 406. Specifically, when assembled the RF pin 406 may be surrounded by the RF insulator eyelet 404, which is further surrounded by the metallic ring 408 and the header 402 thereby creating a coaxial configuration. When the RF pin 406 is carrying RF signals, the RF insulator eyelet 404 may act as an insulator and the header 402 and the metallic ring 408 may act as a shield. Thus, the impedance of the RF pin 406 may be varied by changing any of: the RF insulator eyelet outer diameter 414, the ring thickness 428, the metallic ring height 430, the RF pin diameter 416, the RF insulator height 424, the header thickness 432, the RF pin penetration length 418, the diameter or position on the header 402 of the insulator opening 410, the materials composing any of the above components, or some combination thereof.

Additionally, the RF assembly 400 may confine the electric and magnetic fields to the RF insulator eyelet 404 with little or no leakage outside the metallic ring 408. Additionally, electric and magnetic fields outside the metallic ring 408 and the RF insulator eyelet 404 may cause little or no interference with the RF signals on the RF pin 406.

The described embodiments are to be considered in all respects only as illustrative and not restrictive. The scope of the invention is, therefore, indicated by the appended claims rather than by the foregoing description.

1. An optical subassembly (OSA) comprising:
a header defining an insulator opening and including an internal header surface;
a metallic ring extending above the internal header surface and including a metallic ring inner diameter substantially equivalent to a diameter of the insulator opening;
a radio frequency (RF) insulator eyelet positioned partially in the insulator opening and partially in the metallic ring and defining an RF pin opening; and
an RF pin positioned in the RF pin opening and extending through the insulator opening and the metallic ring.

2. The OSA as recited in claim 1, wherein the insulator opening, the metallic ring, the RF insulator eyelet, and the RF pin are configured to maintain an impedance of the RF pin substantially consistent as the RF pin passes through the insulator opening and through the metallic ring.

3. The OSA as recited in claim 1, wherein the metallic ring is aligned with the insulator opening such that the insulator opening is substantially concentric with the metallic ring.

4. The OSA as recited in claim 1, further comprising a thermoelectric cooler (TEC) positioned above the internal header surface.

5. The OSA as recited in claim 4, wherein a terminal end of the RF pin extends above the internal header surface at least as high as the TEC.

6. The OSA as recited in claim 5, further comprising a transducer positioned above the TEC.

7. The OSA as recited in claim 6, wherein the terminal end of the RF pin is electrically coupled to the transducer.

8. The OSA as recited in claim 7, wherein the insulator opening, the metallic ring, the RF insulator eyelet, and the RF pin are configured to maintain an impedance of the RF pin at the terminal end of the RF pin that substantially matches the impedance of the transducer.

9. An optical subassembly (OSA) comprising:
a header defining an insulator opening and including an internal header surface;
a metallic ring extending above the internal header surface and including a metallic ring inner diameter substantially equivalent to a diameter of the insulator opening, the metallic ring having a terminal end;
a radio frequency (RF) insulator eyelet positioned partially in the insulator opening and partially in the metallic ring and defining an RF pin opening and a terminal end;
an RF pin positioned in the RF pin opening and extending through the insulator opening and the metallic ring, the RF pin including a terminal end that extends roughly to the terminal end of the metallic ring and to the terminal end of the RF insulator eyelet; and
a transducer positioned at roughly the same height above the internal header surface as the terminal ends of the metallic ring, the RF insulator eyelet, and the RF pin.

10. The OSA as recited in claim 9, wherein the insulator opening, the metallic ring, the RF insulator eyelet, and the RF pin are configured to maintain an impedance of the RF pin substantially consistent as the RF pin passes through the insulator opening and through the metallic ring.

11. The OSA as recited in claim 9, further comprising a thermoelectric cooler (TEC) positioned between the internal header surface and the transducer.

12. The OSA as recited in claim 11, further comprising a ceramic sub-mount positioned between the TEC and the transducer.

13. The OSA as recited in claim 9, wherein the terminal end of the RF pin is electrically coupled to the transducer via a bond wire.

14. The OSA as recited in claim 9, wherein the insulator opening, the metallic ring, the RF insulator eyelet, and the RF pin are configured to maintain an impedance of the RF pin at the terminal end of the RF pin that substantially matches the impedance of the transducer.

15. An optoelectronic transceiver module comprising:
a housing;
a printed circuit board (PCB) at least partially positioned within the housing;
a port defined in the housing and configured to receive an optical fiber; and
an optical subassembly (OSA) at least partially positioned within the housing, the OSA comprising:
a header defining an insulator opening and including an internal header surface;
a metallic ring extending above the internal header surface and including a metallic ring inner diameter substantially equivalent to a diameter of the insulator opening, the metallic ring having a terminal end;
a radio frequency (RF) insulator eyelet positioned partially in the insulator opening and partially in the metallic ring and defining an RF pin opening and a terminal end;
an RF pin in electrical communication with the PCB, the RF pin positioned in the RF pin opening and extending through the insulator opening and the metallic ring, the RF pin including a terminal end that extends roughly to the terminal end of the metallic ring and to the terminal end of the RF insulator eyelet;
a thermoelectric cooler (TEC) positioned above the internal header surface; and
a transducer optically aligned with the port and positioned above the TEC at roughly the same height above the internal header surface as the terminal ends of the metallic ring, the RF insulator eyelet, and the RF pin.

16. The optoelectronic transceiver module as recited in claim 15, wherein the insulator opening, the metallic ring, the RF insulator eyelet, and the RF pin are configured to maintain an impedance of the RF pin substantially consistent as the RF pin passes through the insulator opening and through the metallic ring.

17. The optoelectronic transceiver module as recited in claim 15, wherein the header forms a portion of a TO package in the OSA.

18. The optoelectronic transceiver module as recited in claim 15, wherein the terminal end of the RF pin is electrically coupled to the transducer via a bond wire.

19. The optoelectronic transceiver module as recited in claim 15, wherein the insulator opening, the metallic ring, the RF insulator eyelet, and the RF pin are configured to maintain an impedance of the RF pin at the terminal end of the RF pin that substantially matches the impedance of the transducer.

20. The optoelectronic transceiver module as recited in claim 15, wherein the optoelectronic transceiver module is substantially compliant with one of the following MSAs: SFP+, XFP, SFP, SFF, XENPAK, and XPAK.
